(19) United States
(12) Patent Application Publication
(10) Pub. No.: US 2011/0229298 A1
(43) Pub. Date: Sep. 22, 2011

(54) Methods and Devices for Shipping Solar Modules

(76) Inventors: Robert Stancel, Los Alto Hills, CA (US); Louis Basel, San Jose, CA (US)

(21) Appl. No.: 12/988,304

(22) PCT Filed: Apr. 16, 2009
(86) PCT No.: PCT/US2009/040876

§ 371 Date: Jun. 9, 2011

Related U.S. Application Data
(60) Provisional application No. 61/045,595, filed on Apr. 16, 2008.

(51) Int. Cl. B65G 57/00; B65G 57/02

(52) U.S. Cl. 414/802

(57) ABSTRACT

Methods and devices are provided for improved solar module shipping techniques. In one embodiment, the method includes stacking a plurality of glass-based photovoltaic modules in the shipping container, wherein the modules are mounted in a surface supported configuration wherein at least 50% of a top substrate of the modules is a weight bearing surface, transferring weight through cells in the module to a bottom substrate of one of the modules, which transfers weight to a surface of an underlying module.

### FIELD OF THE INVENTION

This invention relates generally to photovoltaic devices, and more specifically, to methods and devices for high density packing and shipping of solar cell modules.

### BACKGROUND OF THE INVENTION

Solar cells and solar cell modules convert sunlight into electricity. Traditional solar cell modules are typically comprised of polycrystalline and/or monocrystalline silicon solar cells mounted on a support with a rigid glass top layer to provide environmental and structural protection to the underlying silicon based cells. This package is then typically mounted in a rigid aluminum or metal frame surrounds the entire perimeter of the module, supports the glass, and provides attachment points for securing the solar module to the installation site. A host of other materials are also included to make the solar module functional. This may include junction boxes, bypass diodes, sealants, and/or multi-contact connectors used to complete the module and allow for electrical connection to other solar modules and/or electrical devices. Certainly, the use of traditional silicon solar cells with conventional module packaging is a safe, conservative choice based on well understood technology.

Drawbacks associated with traditional solar module package designs, however, have limited the ability to install large numbers of solar panels in a cost-effective manner. This is particularly true for large scale deployments where it is desirable to have large numbers of solar modules installed close together in a defined, dedicated area. Traditional solar module packaging comes with a great deal of redundancy and excess equipment cost. For example, a recent installation of conventional solar modules in Pocking, Germany deployed 57,912 monocrystalline and polycrystalline-based solar modules. This meant that there were also 57,912 junction boxes, 57,912 aluminum frames, untold meters of cablings, and numerous other components. These traditional module designs inherit a large number of legacy parts that hamper the ability of installers to rapidly and cost-efficiently deploy solar modules at a large scale. These legacy parts also create substantial bulk to the module and limits how many modules can be sent in each shipping crate. Thus, these conventional designs come with an inherently higher shipping cost due to their bulk and lack of packing density, if such density is based on the number of solar modules or panels in a shipping container.

Although subsidies and incentives have created some large solar-based electric power installations, the potential for greater numbers of these large solar-based electric power installations has not been fully realized. There remains substantial improvement that can be made to photovoltaic cells and photovoltaic modules that can greatly improve their ease of installation, maximize the capacity delivered, and create much greater market penetration and commercial adoption of such products, particularly for large scale installations.

### SUMMARY OF THE INVENTION

Embodiments of the present invention address at least some of the drawbacks set forth above. The present invention provides for the improved shipping methods that maximize density of the number of modules that can be shipped in a container. These improved methods may also reduce the amount of packing material used to ship solar modules without increasing risk of damage. At least some of these and other objectives described herein will be met by various embodiments of the present invention.

In one embodiment of the present invention, a method is provided for photovoltaic module shipping. The method comprises of providing a shipping pallet; stacking a plurality of photovoltaic modules in the shipping pallet, wherein the modules are each positioned in the pallet in a core surface weight bearing configuration, wherein at least 50% but not 100% of a transparent layer of the modules is a weight bearing surface, transferring weight of overlying modules from the transparent layer to at least 50% of the solar cells in the modules and then from the solar cells to a bottom module layer, which transfers weight to any underlying modules. In this embodiment, a central portion of each module in the stack is weight bearing and a full perimeter of each of the modules is not weight bearing. Optionally, the modules each have at least one structure extending beyond a plane of the module, wherein this extended portion prevents stacking in the core surface weight bearing configuration without shifting of the modules along at least one axis.

For any of the embodiments herein, it should be understood that they may be modified to have one or more of the following features. By way of nonlimiting example, the method may include stacking the modules to have weight bearing central portions is achieved without using vertical spacers between modules. Optionally, the modules are positioned without using perimeter spacers between modules. Optionally, the stacking is sufficient to allow for loads of 1500 kg. Optionally, the stacking is sufficient to allow for loads of 1750 kg. Optionally, the stacking is sufficient to allow for loads of 1900 kg. Optionally, the stacking is sufficient to allow for loads of 2000 kg. In one nonlimiting example, this may be the weight of 60 modules have an area of 1 m by 2 m and thickness of about lOmm. There may be anti-stiction sheets and/or powders between modules to prevent sticking between modules in the stack. Optionally, at least 60% of the module surface is weight bearing. Optionally, the modules are frameless modules. Optionally, the modules are glass-glass modules. Optionally, the weight transfer between stacked modules is accomplished without using spacers between adjacent modules of a thickness greater than a height of an electrical connector housing on the modules. Optionally, the modules each further include at least one electrical connector housing. Optionally, wherein the at least one electrical connector housing is located at or near an edge surface of the module. Optionally, at least one electrical connector housing is located within a selected distance from an edge surface of the module, the selected distance being 10% of the long dimension of the module. Optionally, each of the modules includes at least two electrical connector housings, each located along a same edge surface of the module. Optionally, each of the modules includes at least two electrical connector housings, each located along different edge surfaces of the module.

For any of the embodiments herein, it should be understood that they may be modified to have one or more of the following features. For example, the method includes staggering the modules such that the electrical connector housings are not sandwiched between adjacent modules, but that a housing on one module extend along a side surface of an adjacent module, not therebetween. Optionally, the method includes staggering the modules such that a first module is in a first orientation, a second module is in a second orientation, a third module is in a third orientation, and a fourth module is in a fourth orientation, wherein the modules are oriented to locate electrical connector housings to the side of an adjacent module and not inbetween, wherein each of the orientations are unique from each other. Optionally, the method includes staggering the modules such that a first module is in a first orientation, a second module is in a second orientation comprising a Y-rotation and X-translation relative to the first orientation, a third module is in a third orientation comprising an X-rotation and Y-translation relative to the second orientation, and a fourth module is in a fourth orientation comprising a Y-rotation and X-translation relative to the third orientation, wherein the modules are oriented to locate electrical connector housings to the side of an adjacent module and not inbetween, wherein each of the orientations are unique from each other. Optionally, the method may include staggering the modules such that a first module is in a first orientation, a second module is in a second orientation comprising a Y-rotation and X-translation relative to the first orientation, a third module is in a third orientation comprising an X-rotation relative to the second orientation, and a fourth module is in a fourth orientation comprising a Y-rotation and X-translation relative to the third orientation, wherein the modules are oriented to locate electrical connector housings to the side of an adjacent module and not inbetween, wherein each of the orientations are unique from each other. Optionally, at least 60% of the area of a top substrate of the modules is a weight bearing surface. Optionally, at least 70% of the area of a top substrate of the modules is a weight bearing surface. Optionally, at least 80% of the area of a top substrate of the modules is a weight bearing surface. Optionally, at least 90% of the area of a top substrate of the modules is a weight bearing surface.

In another embodiment of the present invention, a method is provide comprising providing a shipping pallet; stacking a plurality of photovoltaic modules in the shipping pallet, wherein the modules are each positioned in the pallet in a core surface weight bearing configuration, wherein at least 50% but not 100% of a transparent layer of each of the modules is a weight bearing surface, transferring weight of overlying modules to at least 50% of the solar cells in the modules and then from the solar cells to a bottom module layer, which transfers weight to any underlying modules. The method includes staggering the modules such that a first module is in a first orientation, a second module is in a second orientation, a third module is in a third orientation, and a fourth module is in a fourth orientation, wherein the modules are oriented to locate electrical connector housings to the side of an adjacent module and not inbetween, wherein each of the orientations are unique from each other.

For any of the embodiments herein, it should be understood that they may be modified to have one or more of the following features. For example, the stacking comprises of repeating the staggering of four modules until the desired number of modules are in the shipping pallet. Optionally, each of the modules has an electrical connection box on one side of the module, wherein each connection box has a height of between 1× module thickness to 2× module thickness. Optionally, one orientation differs from an adjacent module orientation only in lateral shift or translation in one axis. Optionally, one orientation differs from an adjacent module orientation in both a lateral shift in one axis and a rotation about the same or a different axis.

A further understanding of the nature and advantages of the invention will become apparent by reference to the remaining portions of the specification and drawings.

### BRIEF DESCRIPTION OF THE DRAWINGS

FIG. 1 is an exploded perspective view of a module according to one embodiment of the present invention.

FIG. 2 shows a side view of the embodiment of FIG. 1.

FIG. 3 shows a horizontal view of the long edge of two modules stacked on top of each other according to one embodiment of the present invention.

FIG. 4 shows a top down view of the embodiment of FIG. 3.

FIG. 5 shows a horizontal view of the short edge of four modules stacked on top of each other according to one embodiment of the present invention.

FIG. 6 shows a top down view of the embodiment of FIG. 5.

FIG. 7 shows a horizontal view of the long edge of four modules of the embodiment of FIG. 5.

FIG. 8 shows a horizontal view of the short edge of four modules stacked on top of each other according to another embodiment of the present invention.

FIG. 9 shows a top down view of one module configured for use in the embodiment of FIG. 8.

FIG. 10 shows a top down view of the embodiment of FIG. 8.

FIG. 11 shows a horizontal view of the short edge of two modules stacked on top of each other according to one embodiment of the present invention.

FIG. 12 shows a horizontal view of the short edge of two modules stacked on top of each other according to one embodiment of the present invention.

FIG. 13 shows one side of a module with electrical connection boxes according to one embodiment of the present invention.

FIG. 14 shows a top down view of one embodiment of a module with a central junction box.

FIG. 15 shows a top-down view of a stack of four modules according to the embodiment of FIG. 14.

FIG. 16 shows a top down view of one embodiment of a module with an asymmetrically located central junction box.

FIG. 17 shows a top-down view of a stack of four modules according to the embodiment of FIG. 15.

FIGS. 18 and 19 show vertical oriented stacks according to various embodiments of the present invention.

FIG. 20 shows a horizontal view of the short edge of four modules stacked on top of each other according to one embodiment of the present invention.

FIG. 21 shows a top down view of one embodiment of a module with a central junction box.

FIG. 22 shows a top-down view of a stack of four modules according to the embodiment of FIG. 21.

FIG. 23 shows a horizontal view of the short edge of four modules stacked on top of each other according to one embodiment of the present invention.

FIG. 24 shows a top down view of one embodiment of a module with a central junction box.

FIG. 25 shows a top-down view of a stack of four modules according to the embodiment of FIG. 24.

FIG. 26 shows one embodiment wherein the modules of FIG. 25 are in a vertically oriented stack.

FIG. 27 shows a horizontal view of the short edge of four modules stacked on top of each other according to one embodiment of the present invention.

FIG. 28 shows a top down view of one embodiment of a module with a central junction box.

FIG. 29 shows a top-down view of a stack of four modules according to the embodiment of FIG. 28.

FIG. 30 shows a horizontal view of the short edge of four modules stacked on top of each other according to one embodiment of the present invention.

FIG. 31 shows a top down view of one embodiment of a module with a central junction box.

FIG. 32 shows a top-down view of a stack of four modules according to the embodiment of FIG. 31.

FIG. 33 shows a horizontal view of the short edge of four modules stacked on top of each other according to one embodiment of the present invention.

FIG. 34 shows a top down view of one embodiment of a module with a central junction box.

FIG. 35 shows a top-down view of a stack of four modules according to the embodiment of FIG. 34.

FIG. 36 shows a horizontal view of the short edge of four modules stacked on top of each other according to one embodiment of the present invention.

FIG. 37 shows a top down view of one embodiment of a module with a central junction box.

FIG. 38 shows a top-down view of a stack of four modules according to the embodiment of FIG. 37.

FIG. 39 shows a horizontal view of the short edge of four modules stacked on top of each other according to one embodiment of the present invention.

FIG. 40 shows a top down view of one embodiment of a module with a central junction box.

FIG. 41 shows a top-down view of a stack of four modules according to the embodiment of FIG. 40.

FIG. 42 shows a horizontal view of the short edge of four modules stacked on top of each other according to one embodiment of the present invention.

FIG. 43 shows a top down view of one embodiment of a module with a central junction box.

FIG. 44 shows a top-down view of a stack of four modules according to the embodiment of FIG. 43.

FIG. 45 shows a horizontal view of the short edge of four modules stacked on top of each other and supported by a portion of the shipping pallet according to one embodiment of the present invention.

FIG. 46a shows a horizontal view of the short edge of four modules stacked on top of each other and supported by a portion of the shipping pallet according to one embodiment of the present invention.

FIG. 46b shows a horizontal view of the short edge of four modules stacked on top of each other and supported by a portion of the shipping pallet according to one embodiment of the present invention.

FIG. 47 show one embodiment of a device for making electrical connection between modules.

FIG. 48 show another embodiment of a device for making electrical connection between modules.

FIG. 49 shows a shipping pallet according to one embodiment of the present invention.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings^{.}

“Optional” or “optionally” means that the subsequently described circumstance may or may not occur, so that the description includes instances where the circumstance occurs and instances where it does not. For example, if a device optionally contains a feature for an anti-reflective film, this means that the anti-reflective film feature may or may not be present, and, thus, the description includes both structures wherein a device possesses the anti-reflective film feature and structures wherein the anti-reflective film feature is not present.

Photovoltaic Module

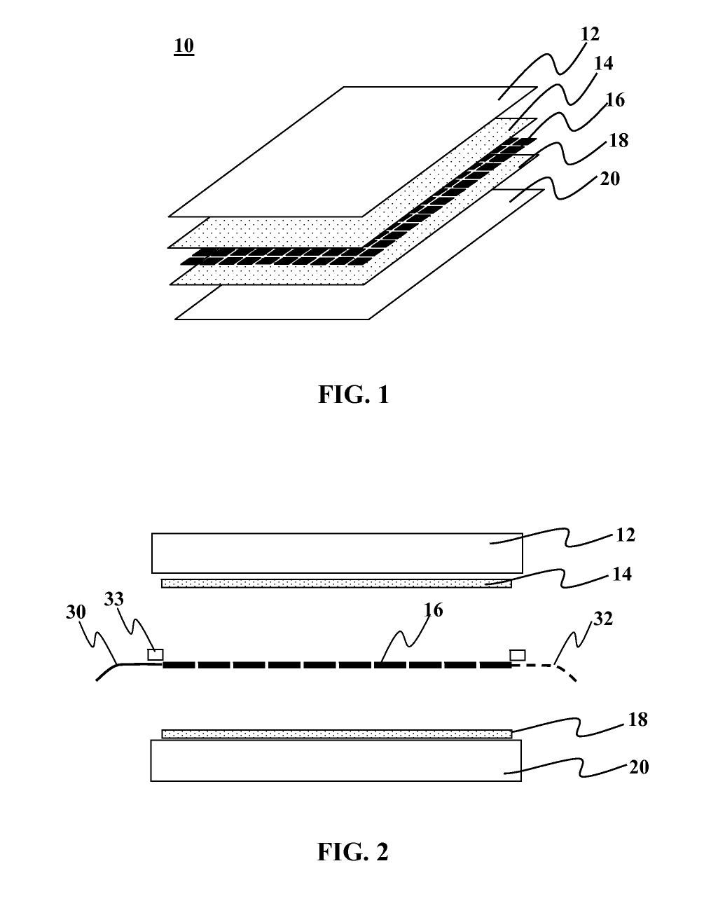

Referring now to FIG. 1, one embodiment of a module 10 according to the present invention will now be described. Traditional module packaging and system components were developed in the context of legacy cell technology and cost economics, which had previously led to very different panel and system design assumptions than those suited for increased product adoption and market penetration. The cost structure of solar modules includes both factors that scale with area and factors that are fixed per module. Module 10 is designed to minimize fixed cost per module and decrease the incremental cost of having more modules while maintaining substantially equivalent qualities in power conversion and module durability. In this present embodiment, the module 10 may include improvements to the backsheet, frame modifications, thickness modifications, and electrical connection modifications. Of course, this example is non-limiting and other module designs may also be adapted for use with the present invention.

FIG. 1 shows that the present embodiment of module 10 may include a transparent upper layer 12 followed by a pottant layer 14 and a plurality of solar cells 16. Below the layer of solar cells 16, there may be another pottant layer 18 of similar material to that found in pottant layer 14. Beneath the pottant layer 18 may be a layer of backsheet material 20. If rigid or semi-rigid, the transparent upper layer 12 provides structural support and acts as a protective barrier. By way of nonlimiting example, the transparent upper layer 12 may be a glass layer comprised of materials such as conventional glass, solar glass, high-light transmission glass with low iron content, standard light transmission glass with standard iron content, anti-glare finish glass, glass with a stippled surface, fully tempered glass, heat-strengthened glass, annealed glass, or combinations thereof The total thickness of the glass or multi-layer glass may be in the range of about 2.0 mm to about 13.0 mm, optionally from about 2.8 mm to about 12.0 mm. In one embodiment, the top layer 12 has a thickness of about 3.2 mm. In another embodiment, the top layer 12 has a thickness of about 0.5 mm to about 8.0 mm. In another embodiment, the top layer 12 has a thickness of about 1.0 mm to about 6.0 mm. In another embodiment, the top layer 12 has a thickness of about 1.0 mm to about 4.0 mm. In another embodiment, the backlayer 20 has a thickness of about 2.0 mm. In another embodiment, the backlayer 20 has a thickness of about about 1.0 mm to about 6.0 mm. As a nonlimiting example, the pottant layer 14 may be any of a variety of pottant materials such as but not limited to Tefzel®, ethyl vinyl acetate (EVA), polyvinyl butyral (PVB), ionomer, silicone, thermoplastic polyurethane (TPU), thermoplastic elastomer polyolefin (TPO), tetrafluoroethylene hexafluoropropylene vinylidene (THV), fluorinated ethylene-propylene (FEP), saturated rubber, butyl rubber, thermoplastic elastomer (TPE), flexibilized epoxy, epoxy, amorphous polyethylene terephthalate (PET), urethane acrylic, acrylic, other fluoroelastomers, other materials of similar qualities, or combinations thereof. Optionally, some embodiments may have more than two pottant layers. The thickness of a pottant layer may be in the range of about 10 microns to about 1000 microns, optionally between about 25 microns to about 500 microns, and optionally between about 50 to about 250 microns. Others may have only one pottant layer (either layer 14 or layer 16). In one embodiment, the pottant layer 14 is about 75 microns in cross-sectional thickness. In another embodiment, the pottant layer 14 is about 50 microns in cross-sectional thickness. In yet another embodiment, the pottant layer 14 is about 25 microns in cross-sectional thickness. In a still further embodiment, the pottant layer 14 is about 10 microns in cross-sectional thickness. The pottant layer 14 may be solution coated over the cells or optionally applied as a sheet that is laid over cells under the transparent module layer 12.

It should be understood that the simplified module 10 is not limited to any particular type of solar cell. The solar cells 16 may be silicon-based or non-silicon based solar cells. By way of nonlimiting example the solar cells 16 may have absorber layers comprised of silicon (monocrystalline or polycrystalline), amorphous silicon, organic oligomers or polymers (for organic solar cells), bi-layers or interpenetrating layers or inorganic and organic materials (for hybrid organic/inorganic solar cells), dye-sensitized titania nanoparticles in a liquid or gel-based electrolyte (for Graetzel cells in which an optically transparent film comprised of titanium dioxide particles a few nanometers in size is coated with a monolayer of charge transfer dye to sensitize the film for light harvesting), copper-indium-gallium-selenium (for CIGS solar cells), CdSe, CdTe, Cu(In,Ga)(S,Se)₂, Cu(In,Ga,AL)(S,Se,Te)₂, IB-IIB-IVA-VIA absorbers, other absorbers, and/or combinations of the above, where the active materials are present in any of several forms including but not limited to bulk materials, micro-particles, nano-particles, or quantum dots. Advantageously, thin-film solar cells have a substantially reduced thickness as compared to silicon-based cells. The decreased thickness and concurrent reduction in weight allows thin-film cells to form modules that are significantly thinner than silicon-based cells without substantial reduction in structural integrity (for modules of similar design).

By way of nonlimiting example, the pottant layer 18 may be any of a variety of pottant materials such as but not limited to EVA, Tefzel®, PVB, ionomer, silicone, TPU, TPO, THV, FEP, saturated rubber, butyl rubber, TPE, flexibilized epoxy, epoxy, amorphous PET, urethane acrylic, acrylic, other fluoroelastomers, other materials of similar qualities, or combinations thereof as previously described for FIG. 1. The pottant layer 18 may be the same or different from the pottant layer 14. Further details about the pottant and other protective layers can be found in commonly assigned, co-pending U.S. patent application Ser. No. 11/462,359 filed Aug. 3, 2006 and fully incorporated herein by reference for all purposes. Further details on a heat sink coupled to the module can be found in commonly assigned, co-pending U.S. patent application Ser. No. 11/465,783 filed Aug. 18, 2006 and fully incorporated herein by reference for all purposes.

FIG. 2 shows a cross-sectional view of the module of FIG. 1. By way of nonlimiting example, the thicknesses of backsheet 20 may be in the range of about 10 microns to about 1000 microns, optionally about 20 microns to about 500 microns, or optionally about 25 to about 250 microns. Again, as seen for FIG. 2, this embodiment of module 10 is a frameless module without a central junction box. The present embodiment may use a simplified backsheet 20 that provides protective qualities to the underside of the module 10. As seen in FIG. 1, the module may use a rigid backsheet 20 comprised of a material such as but not limited to annealed glass, heat strengthened glass, tempered glass, flow glass, cast glass, or similar materials as previously mentioned. The rigid backsheet 20 may be made of the same or different glass used to form the upper transparent module layer 12. Optionally, in such a configuration, the top sheet 12 may be a flexible top sheet such as that set forth in U.S. patent application Ser. No. 11/770,611 filed Jun 28, 2007 and fully incorporated herein by reference for all purposes. In one embodiment, electrical connectors 30 and 32 may be used to electrically couple cells to other modules or devices outside the module 10. A moisture barrier material 33 may also be included along a portion or all of the perimeter of the module.

Module Support System

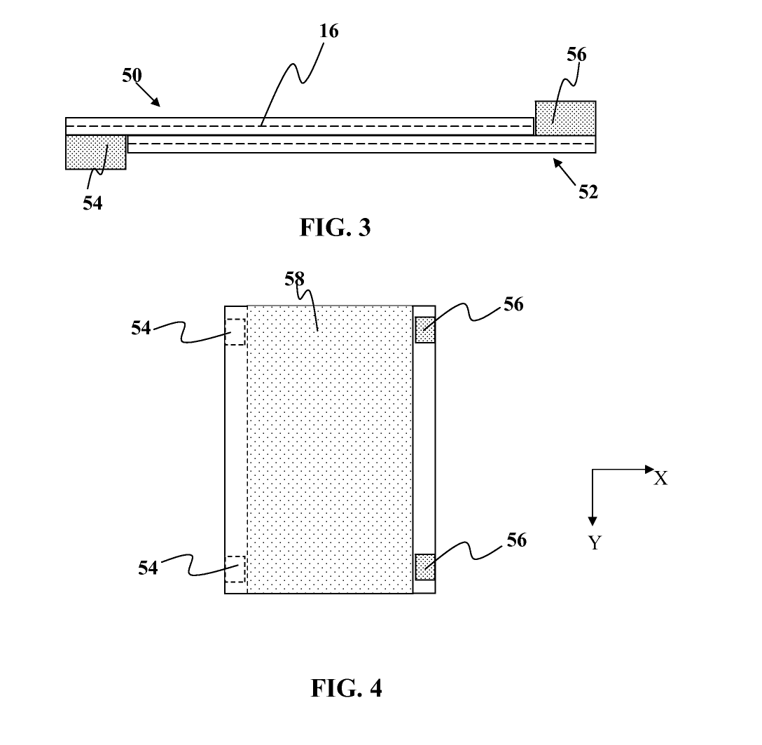

Referring now to FIG. 3, another aspect of the present invention will now be described. FIG. 3 is a side view showing how a glass-glass module 50 may be configured to be surface supported by an underlying glass-glass module 52. As seen in FIG. 3, the substrates that are sandwiching the cells 16 therebetween are the substrates bearing the weight of any overlying module. This allows for a more even distribution of load over the module. The weight of an overlying module is not transferred through a frame surrounding a perimeter of the modules, but instead, the weight is carried by the core, middle portion of the module, through the substrate. This may create a stack of modules having a core surface weight bearing configuration. This is contrary to traditional designs where the weight is distributed to the perimeters of the module where the frame is located, and the frame becomes the main weight bearing member, instead of the central core portion of the module. In traditional designs, the solar cells are not directly weight bearing members, unlike that of the present design.

FIG. 4 shows a top-down view of module 50 being surface supported by underlying glass-glass module 52. As seen in FIG. 4, module 50 includes two electrical connection boxes 54 (shown in phantom), both located close to one edge of the module. FIG. 4 also shows how this embodiment of module 52 includes two electrical connection boxes 56. FIG. 4 shows how the module 52 is shifted in the X-axis to clear the electrical connection boxes 54 and 56 and thus allow the substrates of the modules 50 and 52 to bear weight in surface supported configuration. Specifically, this provide for a core surface supported configuration wherein the central portion of the modules that overlap as indicated by shaded area 58 are the weight carrying areas when the modules are pancake stacked as shown. Although this embodiment is shown terms of a glass-glass module, the packaging and shipping techniques herein are applicable to other module configurations such as but not limited to glass-foil, glass-fiberboard, or other transparent barrier on planar support type modules without a weight bearing perimeter frame.

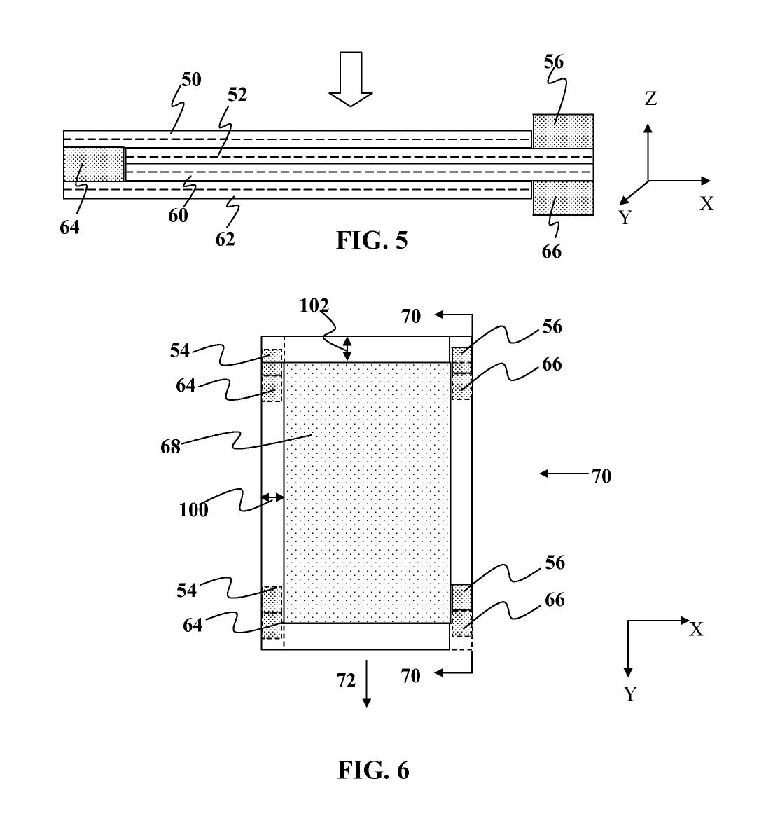

FIG. 5 shows how four modules of the type disclosed in FIGS. 3 and 4 may be stacked in a surface supported configuration. As seen in FIG. 5, the great majority of the modules are supported by the stacking a plurality of glass-based photovoltaic modules in the shipping pallet, wherein the modules are mounted in a surface supported configuration wherein at least 50% of a top substrate of the modules is a weight bearing surface, transferring weight through cells in the module to a bottom substrate of one of the modules, which transfers weight to a surface of an underlying module. In one embodiment, at least 50% of the solar cells in each of stacked modules is carrying load from an overlying module (if any). Thus, the substrates or layersof each module that is sandwiching the cells are supporting the weight of any overlying module(s). As seen, the weight passes through the common center or core portion 68 (shaded for ease of illustration) of most of the modules. This is again different from conventional modules which prefer to transfer weight bearing duties to the perimeter of the module where the non-transparent aluminum frame, steel frame, or other frame of the module is located.

FIG. 5 shows how the present embodiment involves having a unit designed wherein a top module 50 has downward facing connection boxes, a bottom module 62 with upward facing connection boxes, and two middles modules 52 and 60 with a top one with upward facing boxes and a bottom one with downward facing boxes. This creates a building block of four modules that can be stacked in repeating manner using the same configuration of four modules. This is of course a nonlimiting example and other orientations may be used. The rotation and/or translation of the modules are based on the reference axes X-Y-Z as shown in FIG. 5. FIG. 5 is a side-view in the plane of the Y-axis. The connection boxes may be electrical connection boxes and they typically extend above or below the plane of the solar panel. Optionally, some extend outside the perimeter defined by the solar module. Optionally, some embodiments have connection boxes with both features.

FIG. 6 shows a top-down view of module 50 being surface supported by underlying module 52, 62, and 60 which may or may not be glass-glass modules. As seen in FIG. 6, each module 50, 52, 60, and 62 include two junction boxes, both located close to one edge of the module. The stacking involves rotations and/or translations around at least two axes.

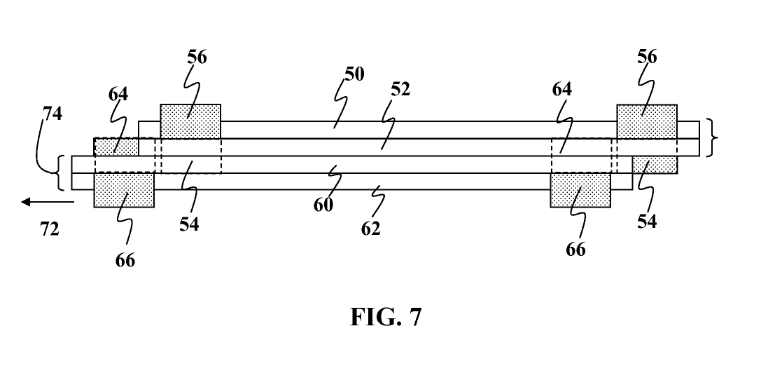

FIG. 7 is a side view in the plane of the X-axis as indicated by arrow 70 in FIG. 6. This more clearly shows how the stacking of modules 50, 52, 60, and 62 also involves translation of the module in the Y-axis as indicated by arrow 72. The modules 60 and 62 as indicated by bracket 74 are translated in the Y-axis to clear the connection box 64 from connection box 54.

Thus, FIG. 7 shows an alternating, staggered stacking configuration for the modules such that a first module 50 is in a first orientation, a second module 52 is in a second orientation, a third module 60 is in a third orientation, and a fourth module 62 is in a fourth orientation, wherein the modules are oriented to locate electrical connector housings to the side of an adjacent module and not in-between, wherein each of the orientations are unique from each other. In one embodiment, the connection box has a maximum height that does not exceed the thickness of an adjoining, adjacent layer. Optionally, as seen in FIG. 7, the maximum thickness of the connection box beyond the plane of the module is between 1× and 2× of the thickness of the panel thickness of the next two modules.

More specifically, FIG. 7 shows a first module 50 in a first orientation, a second module 52 in a second orientation comprising a Y-rotation and X-translation relative to the first orientation, a third module 60 in a third orientation comprising an X-rotation and Y-translation relative to the second orientation, and a fourth module 62 in a fourth orientation comprising a Y-rotation and X-translation relative to the third orientation, wherein the modules are oriented to locate electrical connector housings to the side of an adjacent module and not in-between, wherein each of the orientations are unique from each other.

FIG. 6 shows that the area of overlap comprises of 1) the width of the module minus width 100 and 2) the length of the module minus the length 102. In one embodiment, this length 102 is the lesser of the length of the connection box or the distance from a far end of the connection box to the edge of the module. In one embodiment, the width 100 is either the width of the connection box or the distance from an inside edge of the connection box to the lateral edge of the module.

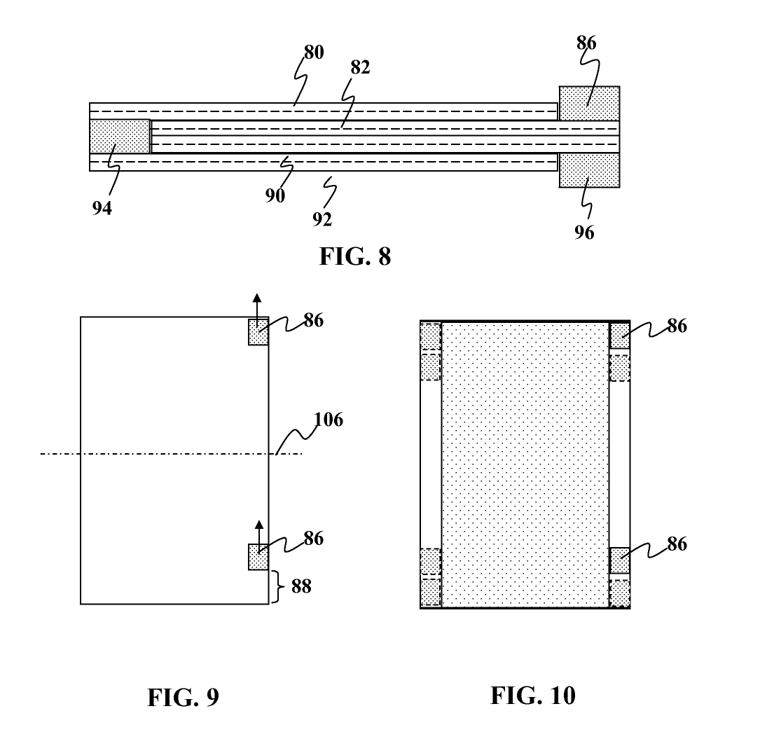

Referring now to FIG. 8, another embodiment of the present invention will now be described. This embodiment shows that the modules 80, 82, 90, and 92 may be stacked in a staggered, surface support configuration similar to that shown in FIG. 5. However, unlike the embodiment shown in FIG. 5, there modules 80, 82, 90, and 92 are more densely stacked that that of FIG. 5. This is due in part to the location of the connection box 86 closer to the corner of the module while a gap 88 is created that is sized to accommodate the length of the connection box from an adjacent module. The connection boxes are asymmetric with regards to their locations relative to their distance to the edges of the module.

FIG. 9 shows that the module 80 has the electrical connection boxes 86 positioned such that one is close to the edge and one is spaced apart as indicated by bracket 88. The asymmetric location of the connection boxes 86 relative to midline 106 allows the modules to be stacked in a surface supported configuration without having to do translations in the Y-axis.

FIG. 10 more clearly shows how the module 80, 82, 90, and 92 are stacked above each other based on translations in the X-axis. This allows for denser packing since the amount of overlap between modules is increased. The area of overlap is calculated using 1) the length of the module times 2) the width of the modules minus the width of the connection box 86. Thus, the outlines of the stack of modules do not need to be increased in the Y-axis in the manner shown in FIG. 6.

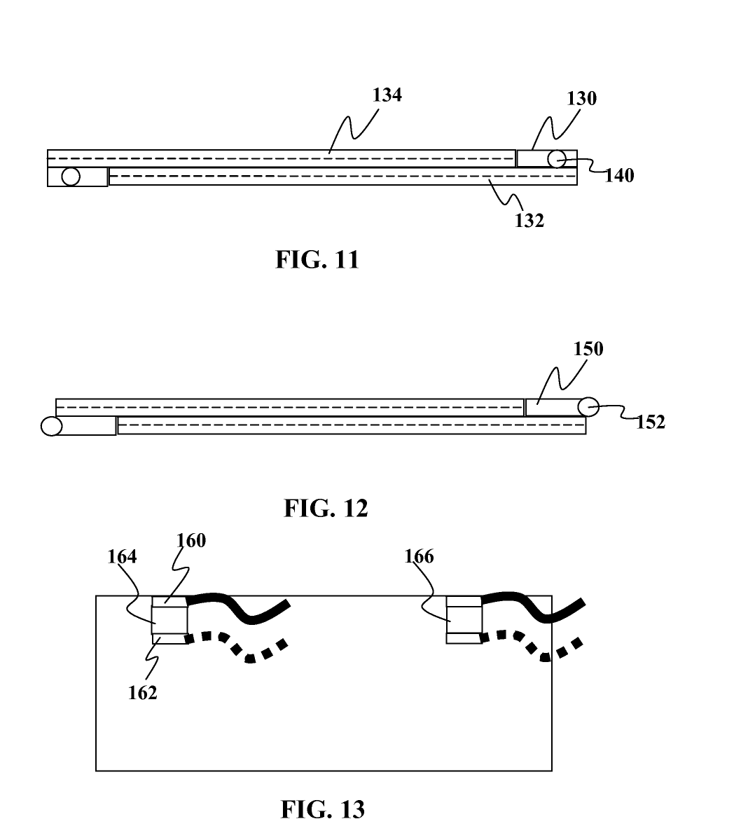

FIG. 11 shows how stacking may be simplified if the height of the connection box 130 above a support surface of the module 132 is less than or equal to the thickness of the adjacent module 132 or 134. As seen in the embodiments of the connection boxes in FIGS. 1 through 10, the connection boxes are greater in height than the thickness of the module and less in height than 2× the height the thickness of the module. The greater than 1× height of the connection boxes above the surface of the module presents some of the challenge in creating surface supported stacking configurations. FIG. 11 shows that to address some of these issues, the wire connector 140 maybe positioned to extend from the connection box 130 in a manner that does not add to the height of the connection box.

FIG. 12 shows another embodiment wherein the wire connector is positioned to extend from a lateral edge of the connection box 150. This wire connector 152 may extend in a manner that extends beyond the perimeter of module as shown in FIG. 12. This allows for the wire connector 152 not to add substantially to the height of the module. Optionally, it is positioned outside the module perimeter and thus in some stacking configurations, does not interfere with stacking of the modules.

As seen in FIG. 13, the wire connectors 160 and 162 may be connected (slidably or otherwise) along an edge of the connection box 164 or 166. These connectors 160 and 162 are seen as being located within the perimeter of the module. Other embodiments may have the connectors 160 and 162 located along the outside perimeter of the module. Optionally, some embodiments has the connectors 160 and 162 located substantially outside the perimeter of the module.

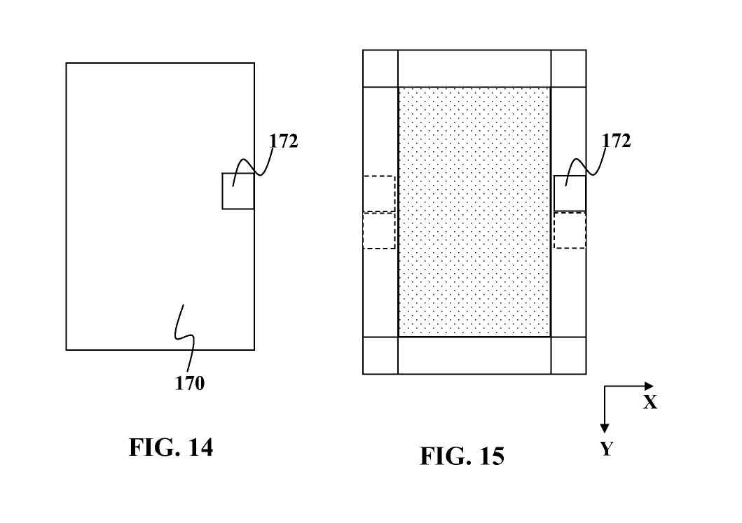

Referring now to FIG. 14, yet another embodiment of the present invention will now be described. FIG. 14 shows a module 170 with a single connection box 172. This may be a central junction box with multiple electrical connectors exiting from that box 172.

FIG. 15 shows how a plurality of these modules may be stacked in a surface supported configuration similar to that shown in FIGS. 5 and 6. FIG. 15 shows a first module 170 in a first orientation, a second module in a second orientation comprising a Y-rotation and X-translation relative to the first orientation, a third module in a third orientation comprising an X-rotation and Y-translation relative to the second orientation, and a fourth module in a fourth orientation comprising a Y-rotation and X-translation relative to the third orientation, wherein the modules are oriented to locate electrical connector housings to the side of an adjacent module and not in-between, wherein each of the orientations are unique from each other.

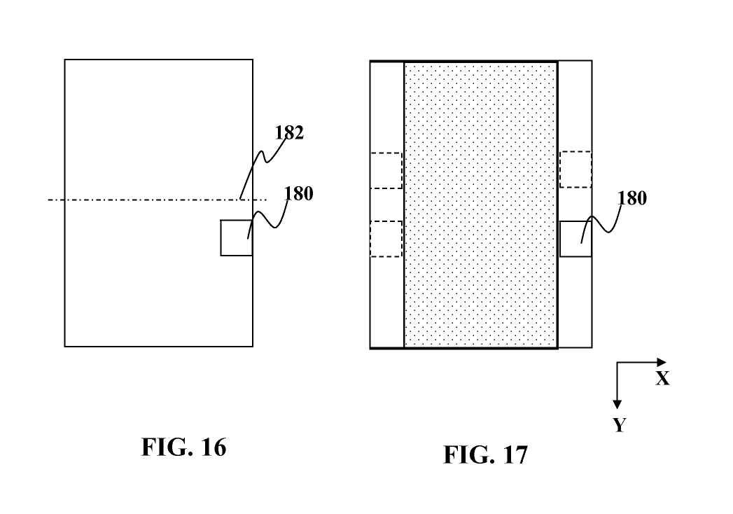

FIG. 16 shows an embodiment wherein the position of the connection box 180 is offset from a centerline 182 in an amount sufficient to allow the modules to be stacked without translation in the Y-axis.

FIG. 17 shows how a plurality of modules may be stacked in a surface supported configuration similar to that shown in FIGS. 8 and 10. In FIG. 17, a first module is in a first orientation, a second module is in a second orientation comprising a Y-rotation and X-translation relative to the first orientation, a third module is in a third orientation comprising an X-rotation relative to the second orientation (without a Y-axis translation), and a fourth module is in a fourth orientation comprising a Y-rotation and X-translation relative to the third orientation (again, no Y-axis translation), wherein the modules are oriented to locate electrical connector housings to the side of an adjacent module and not in-between, wherein each of the orientations are unique from each other.

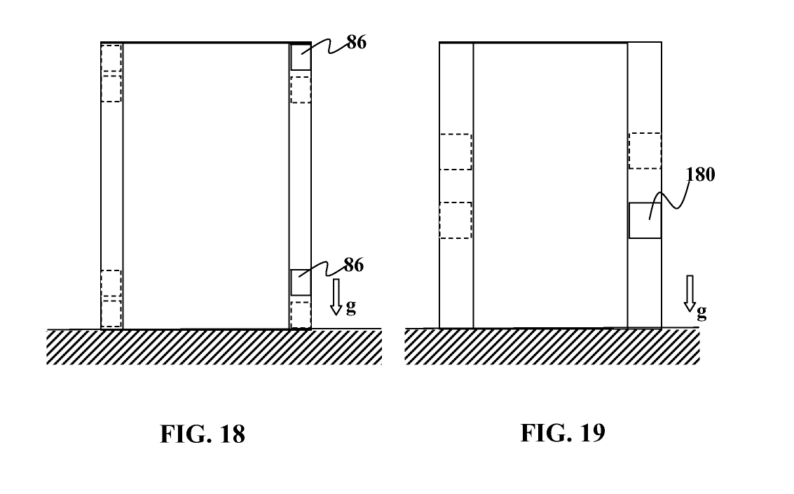

FIGS. 18 and 19 show that stacks of modules with common edge may be stacked vertically (or substantially vertically) instead of in a horizontal fashion as shown in FIGS. 5 and 8. FIG. 18 shows how modules from FIG. 10 may be stacked in a substantially vertical manner. FIG. 19 shows how modules from FIG. 17 may be stacked vertically or substantially vertically. In these embodiments, it is preferable but not necessary that the modules each has at least one edge that contacts the horizontal support surface (which may be a crate, the ground, or a shipping container).

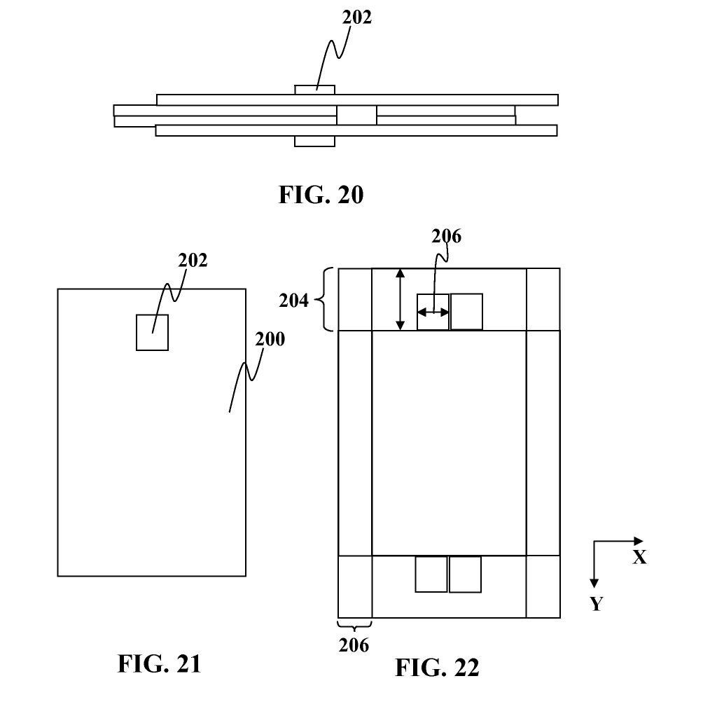

FIGS. 20 through 22 show yet another embodiment of the present invention. FIG. 20 is a horizontal view that shows a stack of four (4) modules that create a “building block” which can be repeated to create larger stacks of modules. FIG. 21 shows one module 200 with a central connection box 202. FIG. 22 shows how the modules may be rotated and translated to create a surface supported configuration similar to that of FIG. 8. FIG. 22 also shows that the distance 204 of the connection box 202 from the edge of the module and the width 206 are used to calculate the area of overlap. The area of overlap is based on a) the length of the module in the X-axis minus distance 206 and b) the length in the module in the Y-axis minus distance 204.

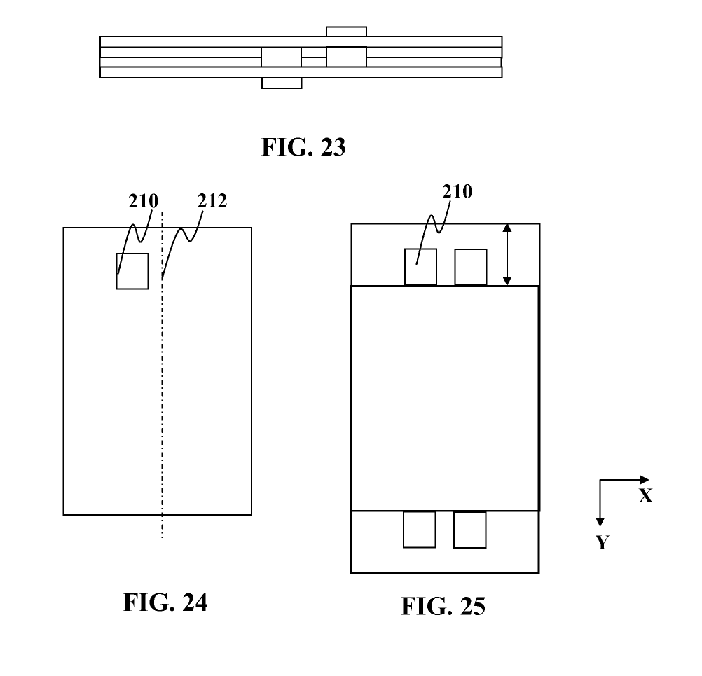

FIGS. 23 through 25 show a still further embodiment of the present invention wherein the connection box 210 is shown to be offset from the centerline 212, as seen in FIG. 24. This offset location of connection box 210 allows the modules to be stacked in a manner similar to that of FIG. 10.

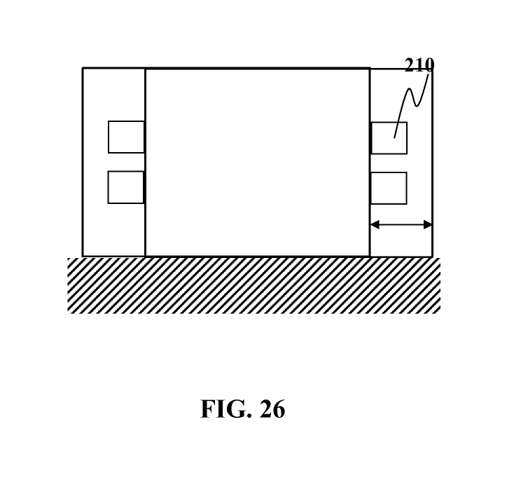

FIG. 26 shows that stack of FIG. 25 may also be oriented in a vertical manner as shown.

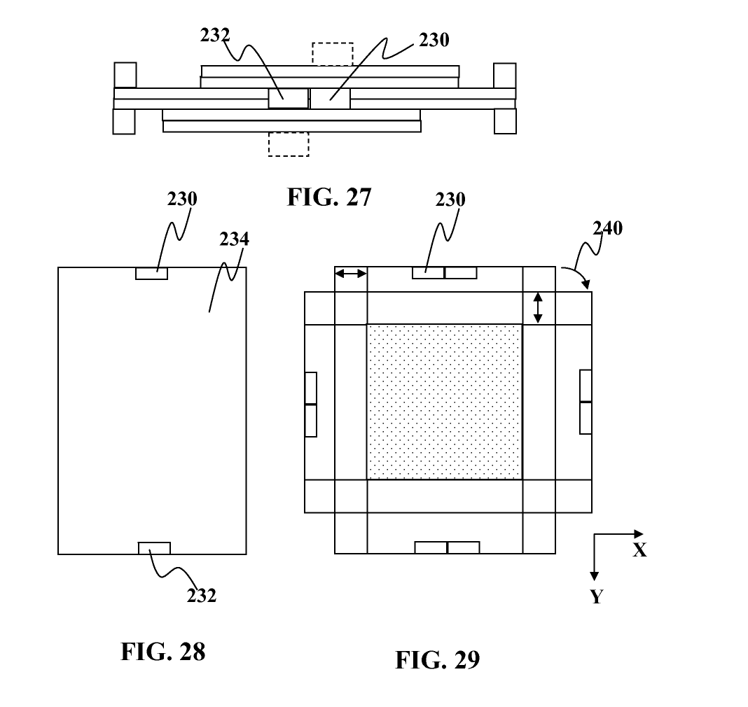

FIGS. 27 through 29 show yet another embodiment of the present invention. FIG. 28 shows that the connection boxes 230 and 232 are located on different edges of the module 234. FIGS. 27 and 29 show that modules may be translated in the X-axis. FIG. 29 also shows that some modules are rotated as indicated by arrow 240 about the Z-axis.

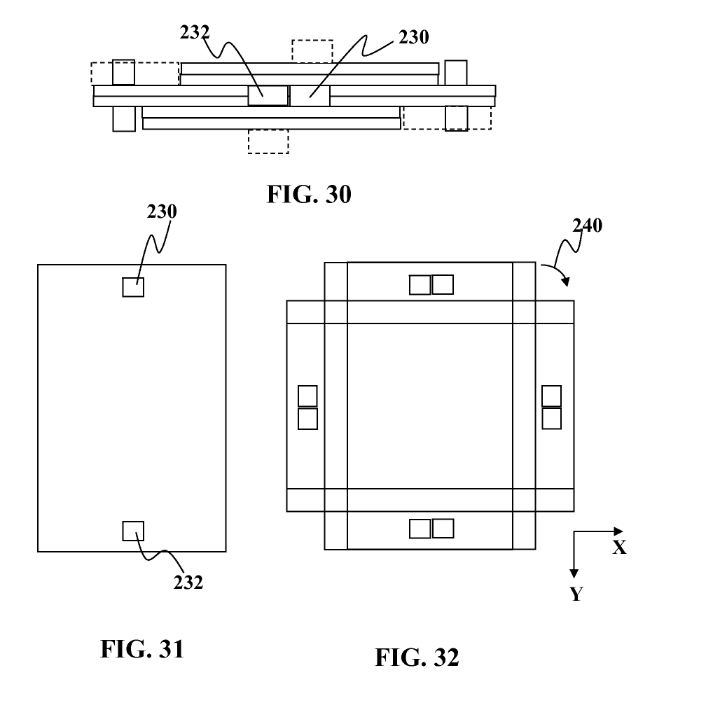

FIGS. 30 through 32 show a similar configuration to that of FIGS. 27 through 29. FIG. 31 shows that the connection boxes 250 and 252 are spaced away from the edges. FIG. 30 shows that spacers 260 (shown in phantom) may be used in areas where portions of the modules are cantilevered.

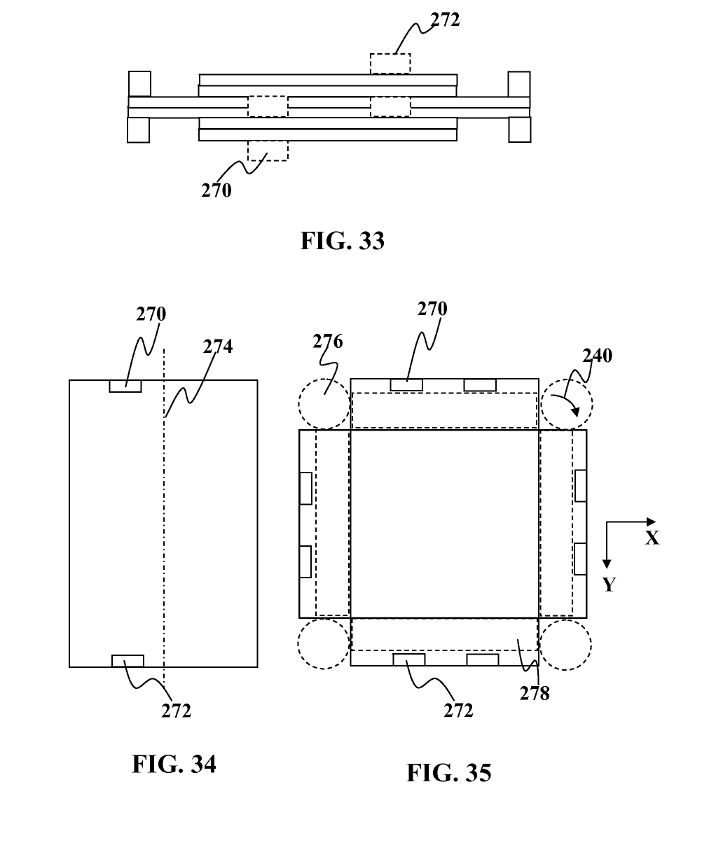

FIGS. 33 through 35 show a still further embodiment wherein the connection boxes 270 and 272 are offset relative to centerline 274. FIG. 35 shows that a variety of spacers 276 and 278 of cylindrical and/or rectangular shape maybe used to support the modules.

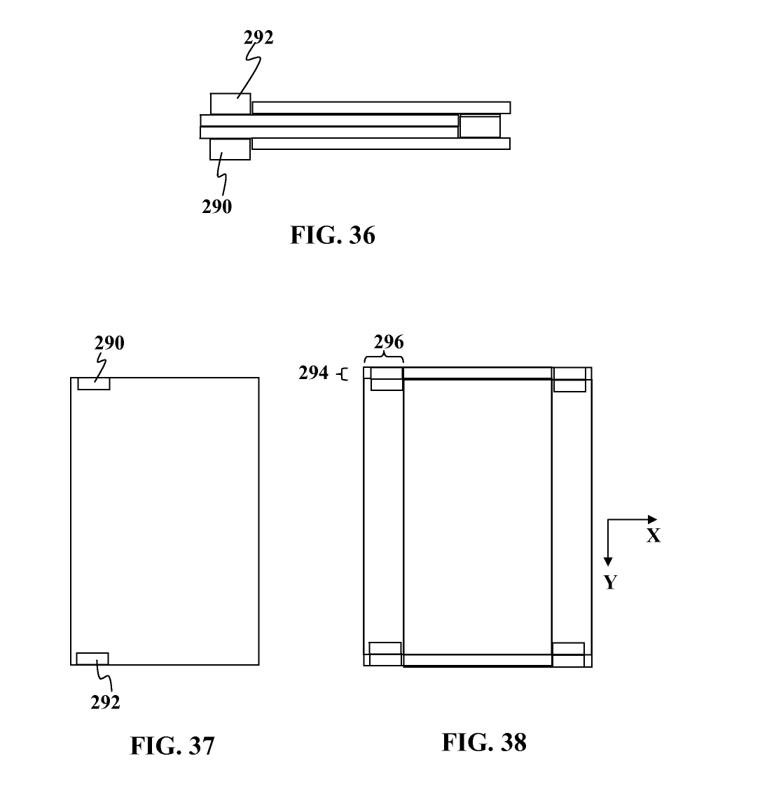

FIGS. 36 through 38 show an embodiment of the present invention using high aspect ratio connection boxes 290 and 292. The boxes 290 and 292 are also positioned closer to the corners of the module. This allows for increased overlap area of the surface support modules as the area is only reduced based on distance 294 and 296. As seen in FIG. 27, the connection boxes are mounted close to different edges of the module. By way of example and not limitation, the aspect ratio (length to width) may be in area of 3:1, 4:1, 5:1, 6:1, or higher. The more narrow the connection box, the less area is typically lost.

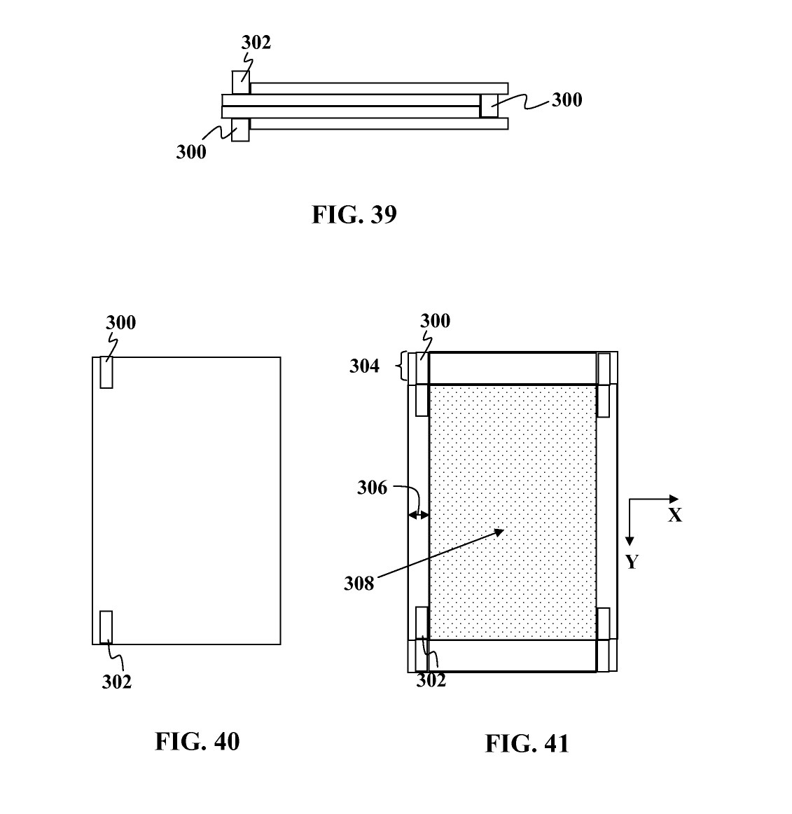

FIGS. 39 through 41 show a similar embodiment to that of FIGS. 36 and 38 except that the connection boxes 300 and 302 are oriented in a different manner. In this embodiment as seen in FIG. 41, the gap or distance 304 is the shift desired to clear the box 300. The distance 306 is the distance from the far edge of the box 302 from the close edge of the module. In this embodiment, distance 306 is also the distance for the shift for the module to allow an adjacent module to clear the box or other structure attached to the module. The shaded area 308 shows the weight bearing area which is the common overlap of all modules in the stack.

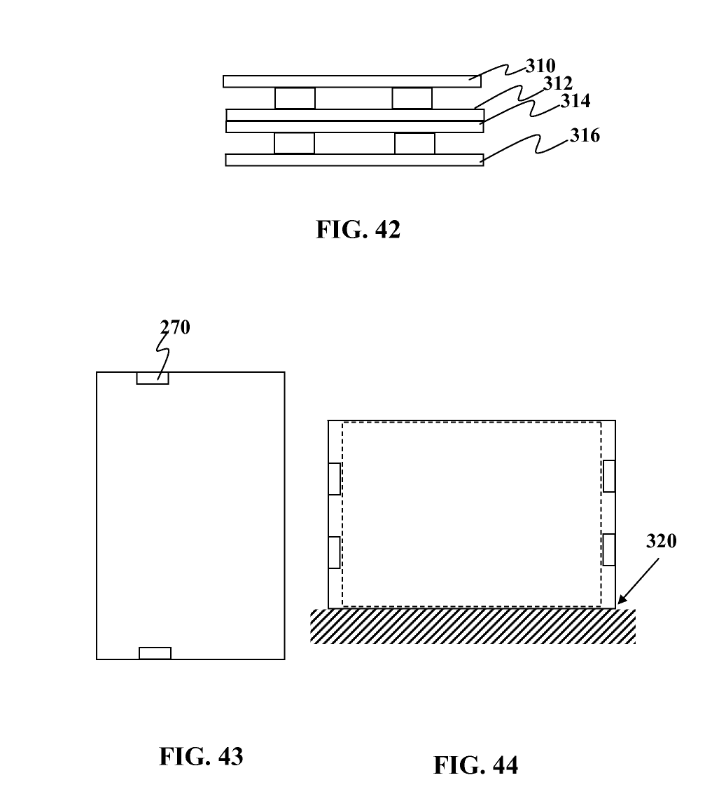

FIGS. 42 through 44 show that even if the modules 310, 312, 314, and 316 are not all in a surface support configuration, they may be used in a vertical orientation since they all have a common edge 320 when the long edge is oriented to be resting on the ground.

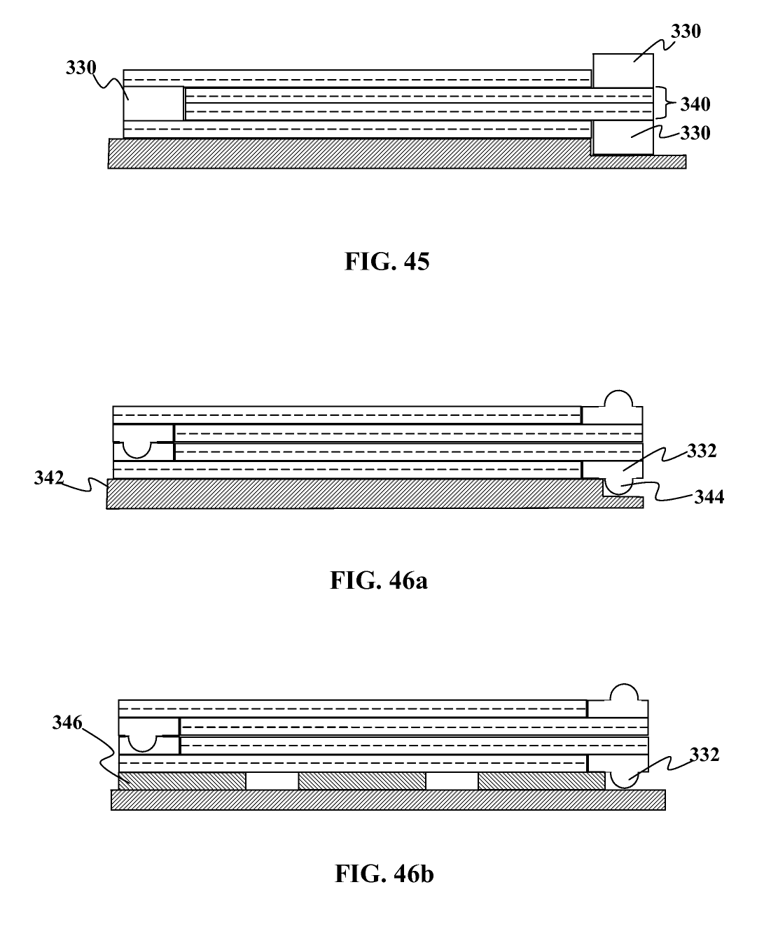

FIGS. 45 and 46 show that there may be carveouts, cutouts, divots, or other surface changes to allow for the extended height of the connection boxes 330 and 332 in the bottom layer of the shipping pallet or container. For example, FIG. 45 shows that the connection boxes may have a height that is close to or equal to twice the thickness of each module as indicated by bracket 340. At minimum in this embodiment, the connection box 300 has a height greater than the thickness of at least one module and is less than or equal to the thickness of two modules. FIG. 46a shows an embodiment wherein there is a cut out in layer 342 to accommodate a rounded portion 344 of the connection box. Optionally, some embodiments may have the two layers of bottom modules with their connection boxes upward facing so that there is enough clearance so that the downward facing connection box is sufficient spaced apart from the bottom of the pallet. Optionally as seen in FIG. 46b, some embodiments may have a spacer layer and/or spacer strips 346 on the shipping pallet to provide sufficient vertical gap so that there will be sufficient clearance for the downward facing connection box.

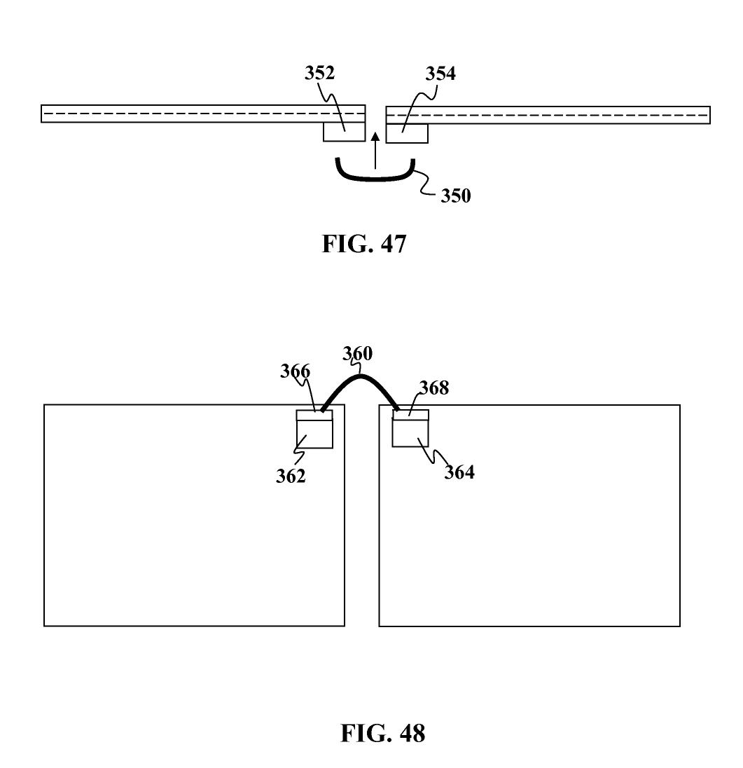

Referring now to FIGS. 47 and 48, it should be understood that some embodiments of the present invention may use wire connector 350 that plug into the connection boxes 352 and 354 (FIG. 47). There may be an opening, female connector, or the like on the connection box to receive the wire connector 350. This may allow for the connection box itself to have a lower profile, such as but not limited to being equal or less high than the thickness of a module.

Optionally, FIG. 48 shows that wire connector 360 may be slidably received by the connection boxes 362 and 364. The ends 366 and 368 may be configured for this slidable connection to the electrical connection box. In this manner, the modules do not need to be shipped with fixed length connectors. Because the electrical cable is added separately at the installation site, the length can be selected of a desired length to make the appropriate electrical connection between modules.

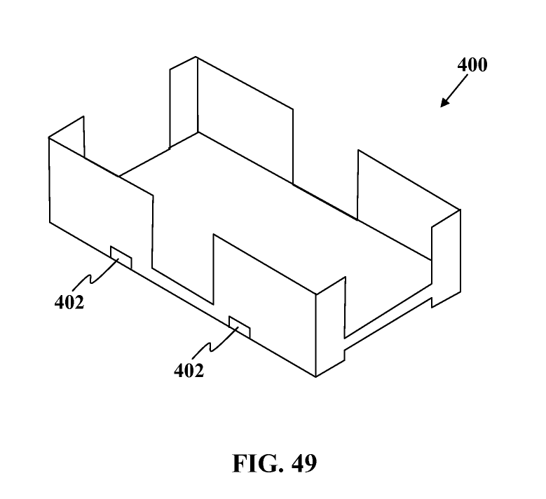

Referring now to FIG. 49, one embodiment of a shipping pallet according to the present invention will now be described. This embodiment shows that the shipping pallet 400 is sized to be sufficient to hold the modules which are horizontally stacked in a “pancake” style orientation. There may be openings 402 to accommodate a forklift. It should be understood that the corners or other portions of the pallet 400 may include posts that extend upward and allow pallets 400 to be stacked on stop of each other. These pallets 400 may also be nested together when empty. As seen in FIG. 49, there is corner protection for the stack of modules. Some modules may have spacers 276 such as but not limited to that shown in FIG. 35 to hold the stack of the modules in their various orientations. In one embodiment, the pallet 400 may be configured to hold up to 60 modules in a volume that has a height of about 600 mm. Optionally, it may hold up to 58 modules in a height of about 600 mm.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, although glass is the layer most often described as the top layer for the module, it should be understood that other material may be used and some multi-laminate materials may be used in place of or in combination with the glass. Some embodiments may use flexible top layers or coversheets. By way of nonlimiting example, the backsheet is not limited to rigid modules and may be adapted for use with flexible solar modules and flexible photovoltaic building materials. Embodiments of the present invention may be adapted for use with superstrate or substrate designs. Other embodiments may have two, three, four, or more connection boxes per module. It should be understood that some paper or anti-stiction material may be placed between modules to prevent adhesion between modules. These layers typically have negligible vertical height and each layer alone is not sufficiently high to be a vertical spacers. Alternatively, other embodiments may optionally use spacers that are large sheets of material and pass weight through the center of the module to an underlying module. These spacer sheets do increase the cost of the shipment due to increase material cost and replacement cost of these layers are lost.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. For example, U.S. Provisional Application Ser. No. 61/045,595 filed Apr. 16, 2008 is fully incorporated herein by reference for all purposes.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for photovoltaic module shipping comprising:

2. The method of claim 1 comprising:
providing a shipping pallet;
stacking a plurality of photovoltaic modules in the shipping pallet, wherein the modules are each positioned in the pallet in a core surface weight bearing configuration, wherein at least 50% but not 100% of a transparent layer of each of the modules is a weight bearing surface, transferring weight of overlying modules to at least 50% of the solar cells in the modules and then from the solar cells to a bottom module layer, which transfers weight to any underlying modules;
wherein a central portion of each module in the stack is weight bearing and a full perimeter of each of the modules is not weight bearing;
wherein the modules each have at least one structure extending beyond a plane of the module which prevents stacking in the core surface weight bearing configuration without shifting of the modules along at least one axis.

3. The method of claim 1 comprising stacking the modules to have weight bearing central portions is achieved without using vertical spacers between modules.

4. The method of claim 1 wherein modules are positioned without using perimeter spacers between modules.

5. The method of claim 1 wherein the stacking is sufficient to allow for loads of 1900 kg.

6. The method of claim 1 wherein the modules are frameless modules.

7. The method of claim 1 wherein the modules are glass-glass modules.

8. The method of claim 1 wherein weight transfer from overlying modules to any underlying modules is accomplished without using spacers between adjacent modules of a thickness greater than a height of an electrical connector housing on the modules.

9. The method of claim 1 wherein the modules each further include at least one electrical connector housing.

10. The method of claim 9 wherein the at least one electrical connector housing is located at or near an edge surface of the module.

11. The method of claim 9 wherein the at least one electrical connector housing is located within a selected distance from an edge surface of the module, the selected distance being 10% of the long dimension of the module.

12. The method of claim 9 wherein each of the modules includes at least two electrical connector housings, each located along a same edge surface of the module.

13. The method of claim 9 wherein each of the modules includes at least two electrical connector housings, each located along different edge surfaces of the module.

14. The method of claim 9 further comprising staggering the modules such that the electrical connector housings are not sandwiched between adjacent modules, but that a housing on one module extend along a side surface of an adjacent module, not therebetween.

15. The method of claim 9 further comprising staggering the modules such that a first module is in a first orientation, a second module is in a second orientation, a third module is in a third orientation, and a fourth module is in a fourth orientation, wherein the modules are oriented to locate electrical connector housings to the side of an adjacent module and not inbetween, wherein each of the orientations are unique from each other.

16. The method of claim 9 further comprising staggering the modules such that a first module is in a first orientation, a second module is in a second orientation comprising a Y-rotation and X-translation relative to the first orientation, a third module is in a third orientation comprising an X-rotation and Y-translation relative to the second orientation, and a fourth module is in a fourth orientation comprising a Y-rotation and X-translation relative to the third orientation, wherein the modules are oriented to locate electrical connector housings to the side of an adjacent module and not inbetween, wherein each of the orientations are unique from each other.

17. The method of claim 9 further comprising staggering the modules such that a first module is in a first orientation, a second module is in a second orientation comprising a Y-rotation and X-translation relative to the first orientation, a third module is in a third orientation comprising an X-rotation relative to the second orientation, and a fourth module is in a fourth orientation comprising a Y-rotation and X-translation relative to the third orientation, wherein the modules are oriented to locate electrical connector housings to the side of an adjacent module and not inbetween, wherein each of the orientations are unique from each other.

18. The method of claim 1 wherein at least 60% of the area of a top substrate of the modules is a weight bearing surface.

19. The method of claim 1 wherein at least 70% of the area of a top substrate of the modules is a weight bearing surface.

20. The method of claim 1 wherein at least 80% of the area of a top substrate of the modules is a weight bearing surface.

21. The method of claim 1 wherein at least 90% of the area of a top substrate of the modules is a weight bearing surface.

22. A method comprising:
providing a shipping pallet;
stacking a plurality of photovoltaic modules in the shipping pallet, wherein the modules are each positioned in the pallet in a core surface weight bearing configuration, wherein at least 50% but not 100% of a transparent layer of each of the modules is a weight bearing surface, transferring weight of overlying modules to at least 50% of the solar cells in the modules and then from the solar cells to a bottom module layer, which transfers weight to any underlying modules;
staggering the modules such that a first module is in a first orientation, a second module is in a second orientation, a third module is in a third orientation, and a fourth module is in a fourth orientation, wherein the modules are oriented to locate electrical connector housings to the side of an adjacent module and not inbetween, wherein each of the orientations are unique from each other.

23. The method of claim 22 wherein stacking comprising of repeating the staggering of four modules until the desired number of modules are in the shipping pallet.

24. The method of claim 22 wherein each of the modules has an electrical connection box on one side of the module, wherein each connection box has a height of between 1× module thickness to 2× module thickness.

25. The method of claim 22 wherein one orientation differs from an adjacent module orientation only in lateral shift or translation in one axis.

26. The method of claim 22 wherein one orientation differs from an adjacent module orientation in both a lateral shift in one axis and a rotation about the same or a different axis.
